(19) United States
(12) Patent Application Publication
(10) Pub. No.: US 2003/0023570 A1
(43) Pub. Date: Jan. 30, 2003

(54) Ranking of documents in a very large database

(76) Inventors: Mei Kobayashi, Kanagawa-ken (JP); Romanos Piperakis, Tokyo-to (JP)

Correspondence Address: Ronald L Drumheller, Esq., 94 Teakettle Spout Road, Mahopac, NY, 10541, US

(21) Appl. No.: 10/155,516

(22) Filed: May 24, 2002

(30) Foreign Application Priority Data
May 25, 2001 (JP) 2001-157614

(51) Int. Cl. G06F 15/18

(52) U.S. Cl. 706/15; 707/3

(57) ABSTRACT

The present invention discloses a method, a computer system, a program product which provide a useful interface to rank the documents in a very large database using neural network(s). The method comprising the steps of: providing a document matrix from said documents, said matrix including numerical elements derived from said attribute data; providing the covariance matrix from said document matrix; computing the eigenvectors of said covariance matrix using neural network algorithm(s); computing inner products of said eigenvectors to create sum S

$$S = {\sum }_{i < j} {e}_{i} \cdot {e}_{j}$$

and examining convergence of said sum S such that difference between the sums becomes not more than a predetermined threshold to determine a final set of said eigenvectors; providing said set of eigenvectors to the singular value decom position of said covariance matrix.

### FIELD OF THE INVENTION

The present invention relates to a method for computing large matrixes, and particularly relates to a method, a computer system, a program product which provide a useful interface to rank the documents in a very large database using neural network(s).

### BACKGROUND OF THE ART

A recent database system becomes to handle increasingly a large amount of data such as, for example, news data, client information, stock data, etc. Use of such databases become increasingly difficult to search desired information quickly and effectively with sufficient accuracy. Therefore, timely, accurate, and inexpensive detection of new topics and/or events from large databases may provide very valuable information for many types of businesses including, for example, stock control, future and options trading, news agencies which may afford to quickly dispatch a reporter without affording a number of reporters posted worldwide, and businesses based on the Internet or other fast paced actions which need to know major and new information about competitors in order to succeed thereof.

Conventionally, detection and tracking of new events in enormous database is expensive, elaborate, and time consuming work, because mostly a searcher of the database needs to hire extra persons for monitoring thereof.

Recent detection and tracking methods used for search engines mostly use a vector model for data in the database in order to cluster the data. These conventional methods generally construct a vector q (kwd1, kwd2, . . . , kwdn) corresponding to the data in the database. The vector q is defined as the vector having the dimension equal to numbers of attributes, such as kwd1, kwd2, . . . kwdn which are attributed to the data. The most commonly used attributes are keywords, i.e., single keywords, phrases, names of person (s), place (s). Usually, a binary model is used to create the vector q mathematically in which the kwd1 is replaced to 0 when the data do not include the kwd1, and the kwd1 is replaced to 1 when the data include the kwd1. Sometimes, a weight factor is combined to the binary model to improve the accuracy of the search. Such a weight factor includes, for example, appearance times of the keywords in the data.

FIG. 1 shows typical methods for diagonalization of a document matrix D which is comprised of the above described vectors where the matrix D is assumed to be an n-by-n symmetric, positive semi-definite matrix. As shown in FIG. 1, the n-by-n matrix D may be diagonalized by two representative methods depending on the size of the matrix D. When n is relatively small in the n-by-n matrix D, the method used may typically be Householder bidiagonalization and the matrix D is transformed to the bidiagonalized form as shown in FIG. 1(a) followed by zero chasing of the bidiagonalized elements to construct the matrix V consisting of the eigenvectors of the matrix D.

In FIG. 1(b) another method for the diagonalization is described, and the diagonalization method shown in FIG. 1(b) may be effective when the number n of the n-by-n matrix D is large or medium. The diagonalization process first executes Lanczos tridiagonalization as shown in FIG. 1(b) followed by Sturm Sequencing to determine the eigenvalues λ₁≧λ₂≧ . . . ≧λᵣ wherein “r” denotes the rank of the reduced document matrix. The process next executes Inverse Iteration so as to determine the i-th eigenvectors associated to the eigenvalues previously found as shown in FIG. 1(b).

So far as a size of the database is still acceptable for application of precise and elaborate methods to complete computation of the eigenvectors of the document matrix D, the conventional methods are quite effective to retrieve and to rank the documents in the database. However, in a very large database, the computation time for retrieving and ranking of the documents becomes sometimes too long for a user of a search engine. There is also a limitation for resources of computer systems such as CPU performance and memory resources for completing the computation.

Therefore, there are needs for providing a system implemented with a novel method for stable retrieving and stable ranking of the documents in the very large database in an inexpensive, automatic manner while saving computational resources.

### DISCLOSURE of the PRIOR ARTS

U.S. Pat. No. 4,839,853 issued to Deerwester et al., entitled “Computer information retrieval using latent semantic structure”, and Deerwester et. al., “Indexing by latent semantic analysis”, Journal of the American Society for Information Science, Vol. 41, No. 6, 1990, pp. 391-407 discloses a unique method for retrieving the document from the database. The disclosed procedure is roughly reviewed as follows;

Step 1: Vector Space Modeling of Documents and Their Attributes

In the latent semantic indexing, or LSI, the documents are modeled by vectors in the same way as in Salton's vector space model and reference: Salton, G. (ed.), The Smart Retrieval System, Prentice-Hall, Englewood Cliffs, NJ, 1971. In the LSI method, the relationship between the query and the documents in the database are represented by an m-by-n matrix MN, the entries are represented by mn (i, j), i.e.,

MN=[mn(i, j)].

In other words, the rows of the matrix MN are vectors which represent each document in the database.

Step 2: Reducing the Dimension of the Ranking Problem via the Singular Value Decomposition

The next step of the LSI method executes the singular value decomposition, or SVD of the matrix MN. Noises in the matrix MN are reduced by constructing a modified matrix Aₖ from the k-th largest singular values σ₁, wherein i=1, 2, 3, . . . , k, . . . , and their corresponding eigenvectors are derived from the following relation;

MNₖ=UₖΣₖVₖ^{T},

Wherein Σₖ is a diagonal matrix with k monotonically decreasing non-zero diagonal elements of σ₁, σ₂, σ₃, . . . , σₖ. The matrices Uₖ and Vₖ are the matrices whose columns are the left and right singular vectors of the k-th largest singular values of the matrix MN.

Step 3: Query Processing

Processing of the query in LSI-based Information Retrieval comprises further two steps (1) query projection followed by (2) matching. In the query projection step, input queries are mapped to pseudo-documents in the reduced document-attribute space by the matrix Uₖ, and then are weighted by the corresponding singular values σᵢ from the reduced rank and singular matrix σₖ. This process may be described mathematically as follows;

$$q \to {}^{hat} \{ q \} = {q}^{T} {U}_{k} {Σ}_{k}^{\{ - 1 \}} ,$$

wherein q represents the original query vector, ^{hat}{q} represents a pseudo-document vector, q^{T} represents the transpose of q, and {−1} represents the inverse operator. In the second step, similarities between the pseudo-document ^{hat}{q} and the documents in the reduced term document space Vₖ^{T} are computed using any one of many similarity measures.

In turn, neural network(s) are often used to compute the eigenvalues and eigenvectors of matrices as reviewed in Golub and Van Loan, 1996 (Matrix Computations, third edition, John Hopkins Univ. Press, Baltimore, Md., 1996). Another computation method using neural network(s) for the eigenvalues and eigenvectors is also reported by Haykin, (Neural Networks: a comprehensive foundation, second edition, Prentice-Hall, Upper Saddle River, N.J., 1999).

Although the above described computations using neural network(s) are effective to reduce computation time and memory resources, there are several problems in reliability of the computation as follows:

(1) The stopping criteria for neural network interations are not clearly understood and guaranteed error bounds are not available through any theorem;

(2) and over-fitting is a common problem with computations of neural network(s).

### SUMMARY of the INVENTION

The present invention is partly made by a recognition that the computation of the eigenvalues and eigenvectors of a large database is significantly improved by providing criteria to indicate a convergence of the sum of the inner products of eigenvectors using covariance matrices.

In the first aspect of the present invention, a method for retrieving and/or ranking documents in a database may be provided. The method comprises the steps of:

providing a document matrix from said documents, said matrix including numerical elements derived from said attribute data;

providing a covariance matrix from said document matrix;

computing eigenvectors of said covariance matrix using neural network algorithm(s);

computing inner products of said eigenvectors to create sum S

$$S = {\sum }_{i < j} {e}_{i} \cdot {e}_{j} ,$$

where eᵢ·eⱼ represents the inner product of eigenvectors eᵢ and eⱼ which have been normalized to have unit length,

and examining convergence of said sum S such that difference between the sums becomes not more than a predetermined threshold to determine a final set of said eigenvectors;

providing said set of eigenvectors to singular value decomposition of said covariance matrix so as to obtain the following formula;

$$K = V \cdot Σ \cdot {V}^{T} ,$$

wherein K represents said covariance matrix, V represents the orthogonal matrix consisting of eigenvectors, Σ represents a diagonal matrix, and V^{T} represents the transpose of the matrix V;

reducing the dimension of said matrix V using predetermined numbers of eigenvectors included in said matrix V, said eigenvectors including an eigenvector corresponding to the largest singular value; and

reducing the dimension of said document matrix using said dimension reduced matrix Vₖ.

In the second aspect of the present invention, a computer system for executing a method for retrieving and/or ranking documents in a database may be provided. The computer system comprises:

means for providing a document matrix from said documents, said matrix including numerical elements derived from said attribute data;

means for providing covariance matrix from said document matrix;

means for computing eigenvectors of said covariance matrix using neural network algorithm(s);

means for computing inner products of said eigenvectors to create said sum S

$$S = {\sum }_{i < j} {e}_{i} \cdot {e}_{j}$$

and examining the convergence of said sum S such that the difference between the sums becomes not more than a predetermined threshold to determine the final set of said eigenvectors;

means for providing said set of eigenvectors of the singular value decomposition of said covariance matrix so as to obtain the following formula;

K=V·Σ·V^{T},

wherein K represents said covariance matrix, V represents the matrix consisting of eigenvectors, Σ represents a diagonal matrix, and V^{T} represents a transpose of the matrix V;

means for reducing the dimension of said matrix V using predetermined numbers of eigenvectors included in said matrix V, said eigenvectors including an eigenvector corresponding to the largest singular value; and

means for reducing the dimension of said document matrix using said dimension reduced matrix Vₖ.

In the third aspect of the present invention, a program product including a computer readable computer program for executing a method for retrieving and/or ranking documents in a database may be provided. The method executes the steps of;

providing a document matrix from said documents, said matrix including numerical elements derived from said attribute data;

providing covariance matrix from said document matrix;

computing eigenvectors of said covariance matrix using neural network algorithm(s);

computing inner products of said eigenvectors to create said sum S

$$S = {\sum }_{i < j} {e}_{i} \cdot {e}_{j}$$

and examining convergence of said sum S such that the difference between the sums becomes not more than a predetermined threshold to determine a final set of said eigenvectors;

providing said set of eigenvectors to the singular value decomposition of said covariance matrix so as to obtain the following formula;

K=V·Σ·V^{T},

wherein K represents said covariance matrix, V represents the matrix consisting of eigenvectors, Σ represents a diagonal matrix, and V^{T} represents a transpose of the matrix V;

reducing the dimension of said matrix V using predetermined numbers of eigenvectors included in said matrix V, said eigenvectors including a eigenvector corresponding to the largest singular value; and

reducing the dimension of said document matrix using said dimension reduced matrix Vₖ.

### BRIEF DESCRIPTION OF THE DRAWINGS

FIG. 1 shows representative methods conventionally used to diagonalize matrixes.

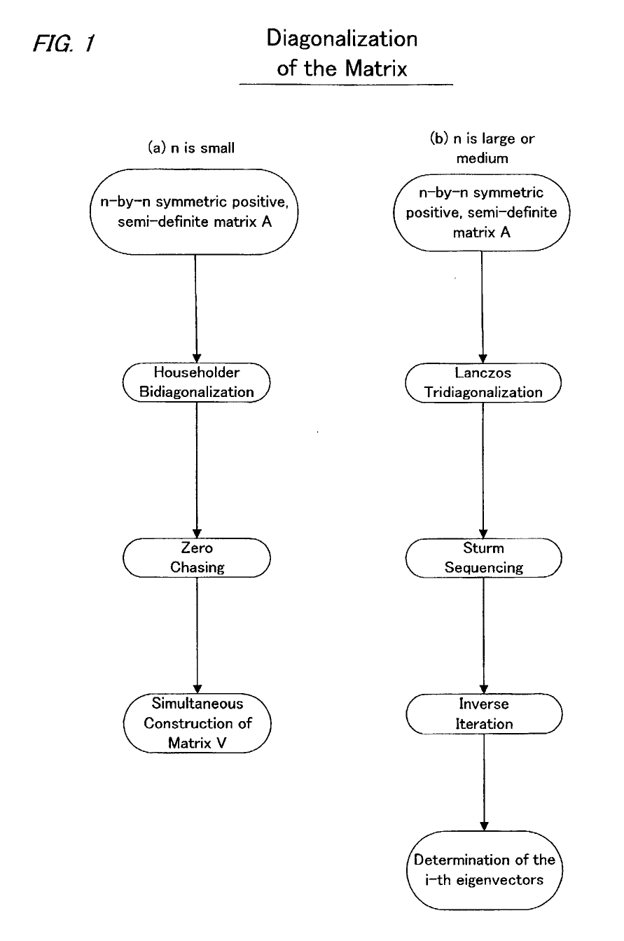

FIG. 2 shows a flowchart of a method according to the present invention.

FIG. 3 shows a schematic construction of a document matrix

FIG. 4 shows schematic procedures for forming the document matrix and for formatting thereof.

FIG. 5 shows a flowchart for computing a covariance matrix.

FIG. 6 shows schematic constructions of the transpose of the document matrix and a mean vector.

FIG. 7 shows a schematic procedure of determination of a set of eigenvalues computed from neural network(s).

FIG. 8 shows a detailed procedure for dimension reduction using the covariance matrix according to the present invention.

FIG. 9 shows a representative computer system according to the present invention.

### BEST MODE for CARRYING OUT the INVENTION

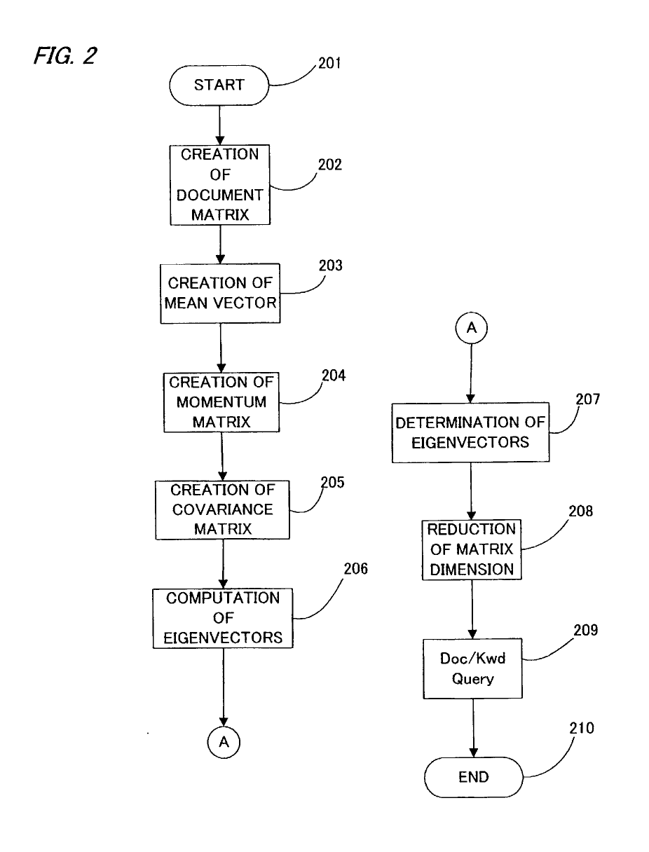

FIG. 2 shows a schematic flowchart of the method according to the present invention. The method according to the present invention starts from the step 201, and proceeds to the step 202 and creates the document matrix D (m-by-n matrix) from the keywords included in the documents. It may be possible to use time stamps simultaneously for creating the document matrix D such as time, date, month, year, and any combination thereof.

The method then proceeds to the step 203 and calculates mean vectors X_{bar} of the document vectors. The method proceeds to the step 204 and computes the momentum matrix B=D^{T}·D/n, wherein B denotes the momentum matrix, and D^{T} denotes the transpose of the document matrix D. The method proceeds to the step 205 and then computes the covariance matrix K by the following formula;

K=B−X_{bar}·X_{bar}^{T},

wherein X_{bar}^{T} denotes the transpose of the mean vector X_{bar}.

The method according to the present invention thereafter proceeds to the step 206 and executes the singular value decomposition of the covariance matrix K as follows;

K=V·Σ·V^{T},

where the rank of the covariance matrix K, i.e., rank (K), is r.

The process next proceeds to the step 207 and calculates the sum of the inner product between the computed eigenvalues from the largest eigenvalue to the predetermined numbers such as top 15-25% using neural network algorithm(s) to provide a set of eigenvectors to the latter procedure.

The method then proceeds to the step 208 and executes dimension reduction of the matrix V such that predetermined numbers k of the eigenvectors corresponding to the eigenvectors having the largest top 15-25% singular value may be included so as to create the dimension reduced matrix Vₖ. The method thereafter proceeds to the step 209 and executes reduction of the document matrix using the dimension reduced Vₖ in order to provide the dimension reduced document matrix, i.e., document subspace used to perform retrieving and ranking of the document with respect to the query vector such as the Doc/Kwd query search, New Event Detection and Tracking as also described in the step 209. Hereafter, the essential steps of the present invention will be discussed in detail.

2. Creation of the Document Matrix

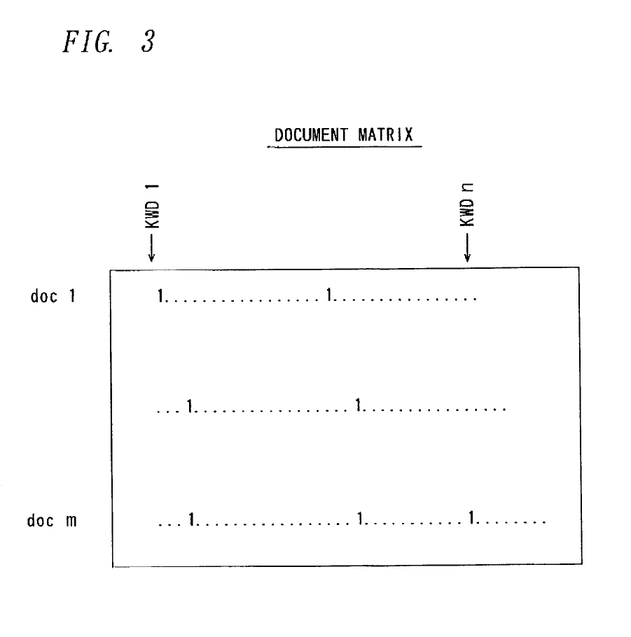

FIG. 3 shows an example of the document matrix D. The matrix D comprises rows from document 1 (doc 1) to document n (doc n) which include elements derived from the keywords (kwd 1, . . . , kwd n) included in the particular document. Numbers of documents and numbers of keyword are not limited in the present invention, and depend on the documents and size of the database. In FIG. 3, the elements of the document matrix D are represented by the numerals 1, however other positive real numbers may be used as when weighting factors are used to create the document matrix D.

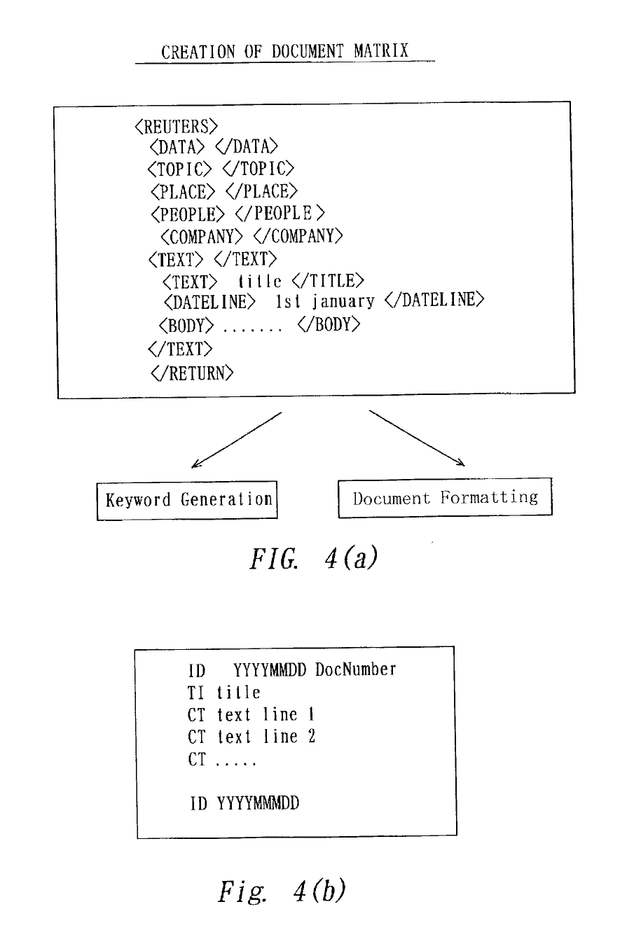

In FIG. 4, an actual procedure for forming the document matrix is shown. In FIG. 4(a), a document written under SGML format is assumed. The method of the present invention generates keywords based on the document with which retrieval and ranking are executed and then converts the format of the document into another format, such as, for example, shown in FIG. 4(b) suitably used in the method according to the present invention. Formats of the documents are not limited to SGML, and other formats may be used in the present invention.

A procedure for the generation of attributes in FIG. 4(a) is described. For example, attributes are considered to be keywords. Keywords generation may be performed as follows;

(1) Extract words with capital letter

(2) Ordering

(3) Calculate number of occurrence(s); n

(4) Remove word if n>Max or n<Min,

(5) Remove stop-words (e.g., The, A, And, There),

wherein Max denotes a predetermined value for maximum occurrence per keyword, and Min denotes a predetermined value for minimum occurrence per keyword. The process listed in (4) may be often effective to improve accuracy. There is not a substantial limitation on the order of executing the above procedures, and the order of the above process may be determined considering system conditions used, and programming facilities. This is one example of a keyword generation procedure and there may be many other procedures possible used in the present invention.

After generating the keywords and converting the SGML format, the document matrix thus built is shown in FIG. 3. A sample pseudo code for creating the document vector/matrix by the binary models without using a weighting factor and/or function is as follows;

REM: No Weighting Factor and/or Function

If kwd (j) appears in doc (i)

Then mn(i, j)=1

Otherwise mn(i, j)=0

The similar procedure may be applied to the time stamps when the time stamps are simultaneously used.

The present invention may use a weighting factor and/or a weighting function with respect to both of the keywords and the time stamps when the document matrix D is created. The weight factor and/or the weight function for the keyword W_{K} may include an occurrence time of the keywords in the document, a position of the keyword in the document, whether or not the keyword being described in capital, but is not limited thereto. A weighting factor and/or weighting function W_{T} for the time stamp may also be applied to obtain the time/date stamp as well as the keyword according to the present invention.

3. Creation of the Covariance Matrix

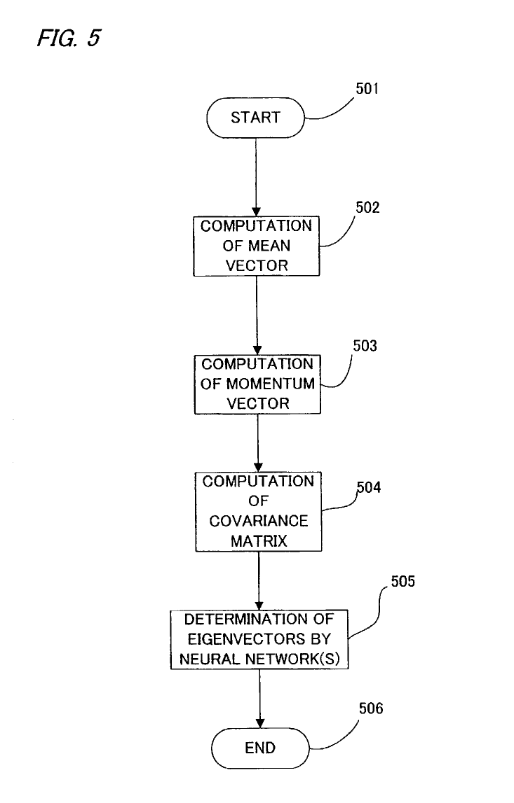

The creation of the covariance matrix comprises generally 4 steps as shown in FIG. 5, that is, the step 502 for computing mean vectors X_{bar}, the step 503 for computing the momentum matrix, the step 504 for computing the covariance matrix, and the step 505 for determining eigenvectors by neural network(s).

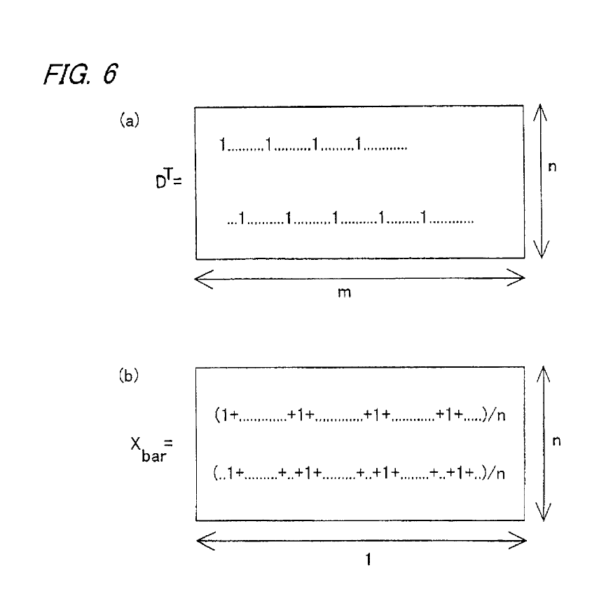

FIG. 6 shows the details of the procedures described in FIG. 5. The mean vectors, X_{bar}, are computed by adding the elements in each of the rows of the transpose of the document matrix D as shown in FIG. 6(a) and dividing the sum of the elements by the document number, i.e., n. The construction of the mean vector X_{bar} is shown in FIG. 6(b), where the transpose of the document matrix D^{T} has n-by-m elements and X_{bar} comprises only one column vector consisted of the mean values of the elements in the same row of A^{T}.

In the step 503, the momentum matrix B is calculated by the following formula;

B=D^{T}·D/n,

wherein D denotes the document matrix and the D^{T} is the transpose thereof. Next the procedure proceeds to the step 504 and computes the covariance matrix K which may be computed by the following formula using the mean vector X_{bar} and the momentum matrix B;

K=B−X_{bar}·X_{bar}.

4. Computation of the Eigenvalues of the Covariance Matrix

The resulted covariance matrix K is a symmetric, positive semi-definite n-by-n structure and the present invention uses neural network algorithm(s) to compute the eigenvalues and eigenvectors of the covariance matrix K. The detail of the computation of the eigenvalues and eigenvectors using neural network is detailed by Golub and Van Loan and Haykin.

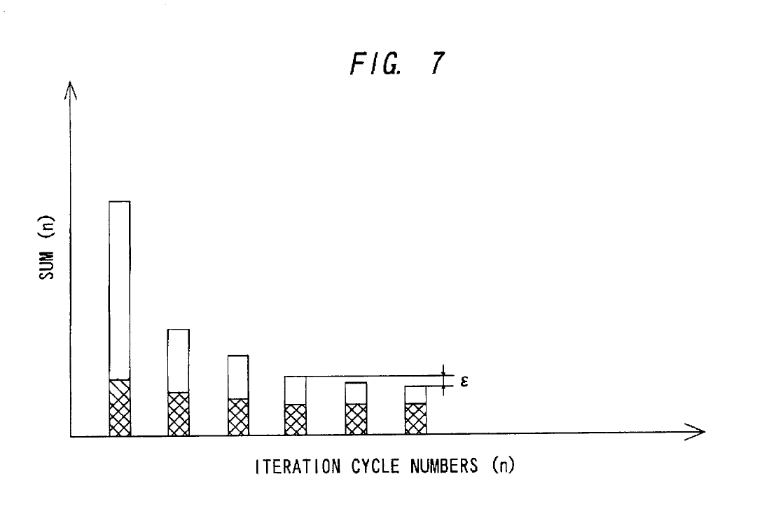

Next the computed eigenvectors are used to generate said sum S(n) of the inner products,

$$S ( n ) = {\sum }_{i < j} {e}_{i ,} \cdot {e}_{j}$$

where eᵢ and eⱼ are i-th and j-th eigenvectors normalized to have unit length computed by neural network(s), respectively and n is the iteration number of the computation using neural network algorithm(s). The sum S(n) is calculated using the eigenvalues of the top 15-20% to reduce the computational resources and the results are not substantially affected in the present invention. The present invention next compares the sum, for example, adjacent sums S (n) and S(n+χ), wherein χ is a whole number larger than or equal to 1. When the difference of the sums ε=S(n+χ)−S(n) becomes not more than a predetermined threshold, the procedure of the present invention determines to terminate the iteration of neural network computation and provide the eigenvectors at that time to calculate the dimension reduction of the covariance matrix. The threshold may be any value for ensuring the convergence of the iteration. FIG. 7 shows a general convergence scheme of the sum S with respect to the iteration cycle summed using the top 100 eigenvectors. Crosshatched regions are the sum of the inner product including the largest inner product of two computed eigenvectors (or the eigenvector corresponding to the largest eigenvalue; or any eigenvector is specified by the user).

As shown in FIG. 7, the sum (n) becomes smaller with respect to the cycle number of the iteration. As the difference of the sum ε becomes equal to or less than the predetermined threshold, the iteration is terminated to determine the set of eigenvectors. In the present invention, it is possible to display the convergence of the sum S shown in FIG. 7 in a display screen of a computer system, such as a client computer so that a user of the system may be aware of the state of the convergence. In the present invention, there is no substantial limitation for the number of the eigenvalues to be summed, and it may be possible to use the top 200, top 400, and top 500 eigenvectors so on.

In another embodiment of the present invention, each estimated eigenvector V may be multiplied to the covariance matrix to generate V′. If the solution is perfect and the multiplication is perfect, then V should be equal to V′. In this case, it is possible to use angles between V and V′ to determine the error of the neural network computation(s).

Further another embodiment of the present invention, it may be possible to incorporate whether or not rotation of the principal axis is possible; such calculation may be executed, for example, the sum of inner product of new rotated eigenvectors is calculated and the convergence of the sum is examined as described above. Such calculation may also be executed, for example, by computing the product V_{new} of the covariance matrix and an eigenvector V computed using neutral network(s) and examining if the inner product V_{new}·V is zero or is very small.

The dimension reduction of the matrix V may be performed such that a predetermined numbers k, of the eigenvectors including the eigenvectors corresponding to the largest singular value is selected to construct k-by-m matrix Vₖ. According to the present invention, the selection of the eigenvectors is performed in various manner as far as the eigenvector corresponds to the largest top k singular value may be included. There is no substantial limitation on the numeral value k, however, the integer value k may preferably be set to about 15-25% of the total number of the eigenvectors so that the retrieving and the ranking of the documents in the database may be significantly improved; when the integer value k is too small, accuracy of the search may decrease, and when the integer value k is too large, advantage of the present invention may be discarded.

4. Dimension Reduction of the Document Matrix

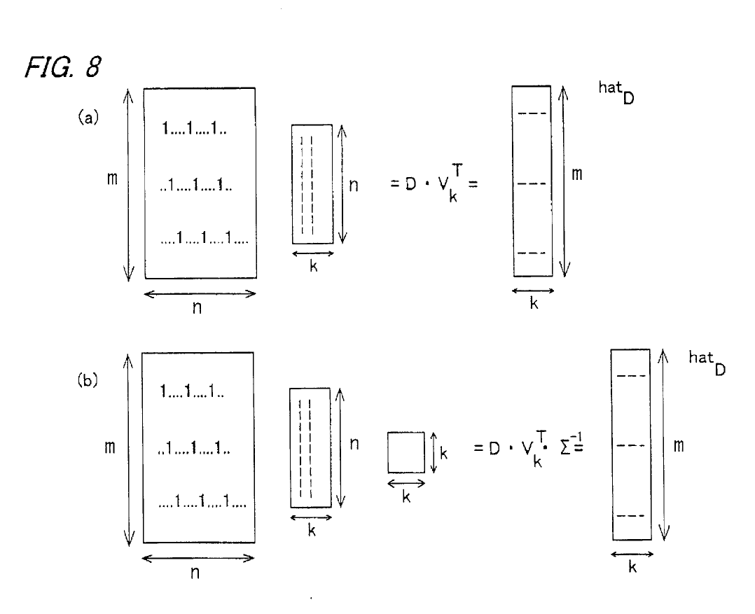

Next the method according to the present invention executes dimension reduction of the document matrix using the matrix Vₖ. The dimension reduction of the document matrix is shown in FIG. 8. The dimension reduced matrix ^{hat}D of the document matrix ^{hat}D, is now simply computed by producing the document matrix D and the matrix Vₖ as shown in FIG. 8(a). It may be possible to add some weighting to the dimension reduced matrix ^{hat}D using the weighting matrix with k-by-k elements as shown in FIG. 8(b). Thus computed matrix ^{hat}D has k-by-m elements, and comprises relatively significant features associated with the keywords. Therefore, the retrieving and ranking of the documents in the database may be significantly improved about the input query by a user of a search engine.

5. Computer System

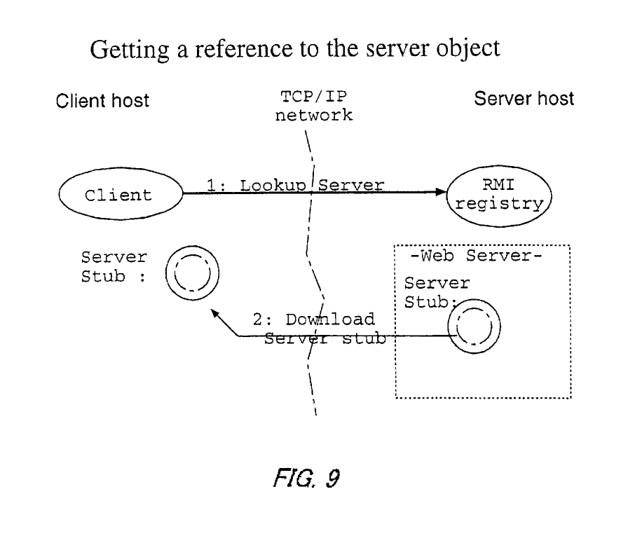

Referring to FIG. 9, a representative embodiment of the computer system according to the present invention is described. The computer system according to the present invention may include a stand alone computer system, a client-server system communicated through LAN/WAN with any conventional protocols, or a computer system including communication through an Internet infra base. In FIG. 9, the representative computer system effective in the present invention is described using client-server systems.

The computer system shown in FIG. 9 comprises at least one client computer and a server host computer. The client computer and the server host computer are communicated through a communication protocol of TCP/IP, however any other communication protocols may be available in the present invention. As described in FIG. 9, the client computer issues a request 1 to the server host computer to carry out retrieving and ranking the documents stored in memory by means of the server host computer.

The server host computer executes retrieving and ranking the documents of the database depending on the request from the client computer. A result of the detection and/or tracking is then downloaded by the client computer from the server host computer through the server stub so as to be used by a user of the client computer. In FIG. 9, the server host computer is described as the Web server, but is not limited thereto, server hosts in any other types may be used in the present invention so far as computer systems provide the above described function.

The method according to the present invention is also stable against addition of new documents to the database, because the covariance matrix is used to reduce the dimension of the document matrix and only 15-25% of the largest i-th eigenvectors, which are not significantly sensitive to the addition of new documents to the database, are used. Therefore, when once the covariance matrix are formed, many searches may be performed without elaborate and time consuming computation for the singular value decomposition each time the search is performed as for as the accuracy of the search is maintained, thereby significantly improving the performance.

As described above, the present invention has been described with respect to the specific embodiments thereof. However, a person skilled in the art may appreciate that various omissions, modifications, and other embodiments are possible within the scope of the present invention.

The present invention has been explained in detail with respect to the method for retrieving and ranking as well as detection and tracking, however, the present invention also contemplates to include a system for executing the method described herein, a method itself, and a program product within which the program for executing the method according to the present invention may be stored such as for example, optical, magnetic, electro-magnetic media. The true scope can be determined only by the claims appended.

1. A method for retrieving and/or ranking documents in a database, said method comprising the steps of:
providing a document matrix from said documents, said matrix including numerical elements derived from said attribute data;
providing covariance matrix from said document matrix;
computing eigenvectors of said covariance matrix using neural network algorithm(s);
computing inner products of said eigenvectors to create the said sum S
$$S = {\sum }_{i < j} {e}_{i} \cdot {e}_{j}$$
and examining convergence of said sum S such that difference between the sums becomes not more than a predetermined threshold to determine the final set of said eigenvectors;
providing said set of eigenvectors to the singular value decomposition of said covariance matrix so as to obtain the following formula;
K=V·Σ·V^{T},
wherein K represents said covariance matrix, V represents the matrix consisting of eigenvectors, Σ represents a diagonal matrix, and V^{T} represents the transpose of the matrix V;
reducing the dimension of said matrix V using predetermined numbers of eigenvectors included in said matrix V, said eigenvectors including an eigenvector corresponding to the largest singular value; and
reducing the dimension of said document matrix using said dimension reduced matrix V.

2. The method according to the claim 1, said method further comprises the step of;
retrieving and/or ranking said documents in said database by computing the scalar product between said dimension reduced document matrix and a query vector.

3. The method according to the claim 1, wherein said covariance matrix is computed by the following formula;
K=B−X_{bar}·X_{bar}^{T},
wherein K represents a covariance matrix in said covariance matrix, B represents a momentum matrix, X_{bar} represents a mean vector and X_{bar}^{T} represents a transpose thereof.

4. The method according to the claim 1, wherein said sum are created from 15-25% of the total of the eigenvectors of said covariance matrix.

5. A computer system for executing a method for retrieving and/or ranking documents in a database comprising:
means for providing a document matrix from said documents, said matrix including numerical elements derived from said attribute data;
means for providing the covariance matrix from said document matrix;
means for computing eigenvectors of said covariance matrix using neural network algorithm(s);
means for computing inner products of said eigenvectors to create sum S
$$S = {\sum }_{i < j} {e}_{i} \cdot {e}_{j}$$
and examining convergence of said sum S such that difference between the sums becomes not more than a predetermined threshold to determine a final set of said eigenvectors;
means for providing said set of eigenvectors to the singular value decomposition of said covariance matrix so as to obtain the following formula;
K=V·Σ·V^{T},
wherein K represents said covariance matrix, V represents the matrix consisting of eigenvectors, Σ represents a diagonal matrix, and V^{T} represents the transpose of the matrix V;
means for reducing the dimension of said matrix V using predetermined numbers of eigenvectors included in said matrix V, said eigenvectors including an eigenvector corresponding to the largest singular value; and
means for reducing the dimension of said document matrix using said dimension reduced matrix V.

6. The computer system according to the claim 5, wherein said computer system further comprises:
means for retrieving and/or ranking said documents in said database by computing the scalar product between said dimension reduced document matrix and a query vector.

7. The computer system according to the claim 6, wherein said covariance matrix is computed by the following formula;
K=B−X_{bar}·X_{bar}^{T},
wherein K represents the covariance matrix in said covariance matrix, B represents a momentum matrix, X_{bar} represents a mean vector and X_{bar}^{T} represents the transpose thereof.

8. The computer system according to the claim 6, wherein said sum are created from 15-25% of the total of the eigenvectors of said covariance matrix.

9. A program product including a computer readable computer program for executing a method for retrieving and/or ranking documents in a database, said method comprising the steps of; providing a document matrix from said documents, said matrix including numerical elements derived from said attribute data;
providing the covariance matrix from said document matrix;
computing eigenvectors of said covariance matrix using neural network algorithm(s);
computing inner products of said eigenvectors to create the said sum S
$$S = {\sum }_{i < j} {e}_{i} \cdot {e}_{j}$$
and examining the convergence of said sum S such that the difference between the sums becomes not more than a predetermined threshold to determine a final set of said eigenvectors;
providing said set of eigenvectors to the singular value decomposition of said covariance matrix so as to obtain the following formula;
K=V·Σ·V^{T},
wherein K represents said covariance matrix, V represents the matrix consisting of eigenvectors, Σ represents a diagonal matrix, and V^{T} represents the transpose of the matrix V;
reducing the dimension of said matrix V using predetermined numbers of eigenvectors included in said matrix V, said eigenvectors including a eigenvector corresponding to the largest singular value; and
reducing the dimension of said document matrix using said dimension reduced matrix V.

10. The program product according to the claim 9, wherein said method further comprising the step of;
retrieving and/or ranking said documents in said database by computing scalar product between said dimension reduced document matrix and a query vector.

11. The program product according to the claim 19, wherein said covariance matrix is computed by the following formula;
K=B−X_{bar}·X_{bar}^{T},
wherein K represents a covariance matrix in said covariance matrix, B represents a momentum matrix, X_{bar} represents a mean vector and X_{bar}^{T} represents a transpose thereof.

12. The program product according to the claim 9, wherein said sum are created from 15-25% of the total of the eigenvectors of said covariance matrix.

13. A computer system comprising:
means for providing a matrix from including numerical elements;
providing covariance matrix from said matrix;
means for computing eigenvectors of said covariance matrix using neural network algorithm(s);
means for computing inner products of said eigenvectors to create the said sum S
$$S = {\sum }_{i < j} {e}_{i} \cdot {e}_{j}$$
and examining convergence of said sum S such that difference between the sums becomes not more than a predetermined threshold to determine a final set of said eigenvectors;
means for providing said set of eigenvectors to the singular value decomposition of said covariance matrix so as to obtain the following formula;
K=V·Σ·V^{T},
wherein K represents said covariance matrix, V represents the matrix consisting of eigenvectors, Σ represents a diagonal matrix, and V^{T} represents a transpose of the matrix V;
means for reducing the dimension of said matrix V using predetermined numbers of eigenvectors included in said matrix V, said eigenvectors including an eigenvector corresponding to the largest singular value; and
means for reducing the dimension of said matrix using said dimension reduced matrix V.

14. The computer system according to the claim 13, wherein said sum are created from 15-25% of the total of the eigenvectors of said covariance matrix.
